(19) United States
(12) Patent Application Publication
(10) Pub. No.: US 2004/0200939 A1
(43) Pub. Date: Oct. 14, 2004

(54) Concrete foundation form system

(76) Inventor: Matthew R. Morse SR., Portland, OR (US)

Correspondence Address: Matthew R. Morse Sr., 5215 N. Denver Ave., Portland, OR, 97217, US

(21) Appl. No.: 10/412,891

(22) Filed: Apr. 14, 2003

(51) Int. Cl. F16B 1/00

(52) U.S. Cl. 248/229.1

(57) ABSTRACT

Multiple variable sizing concrete form supports are provided at spaced intervals. Each support device is attached to a post, driven into the ground along the vertical axis, and is also attached to a horizontal bar containing a form support cradle. Both axes slide through the clamping mechanism.

### FIELD OF THE INVENTION

The present invention relates to setting temporary concrete forms for flat concrete work generally, and more particularly to concrete forms for sidewalks, driveways, curbs, and streets that are installed prior to pouring concrete and then removed after the concrete has set.

### BACKGROUND OF THE INVENTION

For typical current construction techniques, forms and foundations for pouring sidewalks, curbs, driveways, streets, etc., are constructed by pounding wooden stakes into the ground along the perimeter of the proposed concrete area and then typically 2×4s, 2×6s, or similar boards are placed horizontally on the graded ground at the appropriate places and then nailed to the wooden stakes. Then the exact dimensions of the concrete area are delineated and the wooden 2×4 forms are-moved accordingly by hand and hammer.

Difficulties and inefficiencies arise in the following areas with current practices: It is time-consuming, and therefore expensive in terms of labor, to repeatedly adjust the positioning of the wooden forms to exactly match the intended dimensions of the concrete along both the vertical and horizontal axes. It is sometimes difficult to get the wooden stakes to remain firmly in the ground when they have been disturbed or moved. The set forms are easily disturbed when left over night and are unattended. Finally, the set forms are not as accurately positioned as the original design and designer intended and therefore do not ultimately produce the final product dimensions that are designed or desired.

The present invention overcomes the above-mentioned difficulties by reducing the time necessary to install the concrete forms in the generally correct position and then exactly in the correct position prior to the placement of cement. Because the invention is variable, scalable and identical in multiple units, workers can rapidly install multiple form supports with confidence that their placement will be accurate for final calibration and placement of cement. The present invention, comprised substantially or entirely of metal, is rigid and firm when driven correctly into the ground. This rigidity produces a form support in the correct position that is not easily moveable. If, however, it is slightly disturbed, it can be quickly (re)calibrated or (re)positioned along the horizontal and/or vertical axes.

Finally, the present invention, when placed correctly, can be adjusted and/or positioned to an unlimited number of positions along the vertical and horizontal axes.

By use of this form support, it is therefore a principal object of this invention to accurately and quickly set a temporary form support with multiple independent parts connected by the forms used on site.

### SUMMARY OF THE INVENTION

By means of the present invention, moldable and pourable materials such as concrete may be more efficaciously placed into desired configurations more rapidly, with less effort, and therefore more cost effectively.

In a particular embodiment, the variable sizing foundation form is comprised of a vertical metal cylindrical pole, a horizontal metal cylindrical pole with the form supporting bracket on one end, and the clamping plate, through which both vertical and horizontal poles slide.

In this particular embodiment, the clamping plate has two enclosed cylinders, one vertical and one horizontal, through which the vertical pole and horizontal pole pass. Both enclosed cylinders are offset on the clamping plate, with the vertical cylinder being on the lower edge of the plate and the horizontal cylinder being on the front, or right side of the plate.

Further, each cylinder is penetrated at approximately the midpoint by a threaded hole through which passes a threaded bolt with a circular tightening handle. The tightening bolt is pointed and/or scored at the interior tip and interrupts or stops the sliding movement of the pole or stake passing through the cylinder.

Further, the operative end of the horizontal pole is a clamping support plate that supports the horizontal wooden cement form running perpendicularly to the horizontal axis of the invention; typically a 2×4, or a 2×6.

The device in its entirety is firmly placed in the ground, firmly holds the temporary cement form and provides easy variable adjustment along both the vertical and horizontal axes.

### BRIEF DESCRIPTION OF THE DRAWINGS

FIG. 1 is a side view of the concrete form system as presently proposed showing the clamping plate (1), the horizontal pipe (2), the vertical pipe (3), the two threaded clamping set screws (4), the form support (5), the nail set holes (6), the gripping teeth (7) with the invention installed in the ground (8).

FIG. 2 is a front view of the same concrete form system as shown in FIG. 1, with the form support plate removed from the horizontal pole for the sake of clarity.

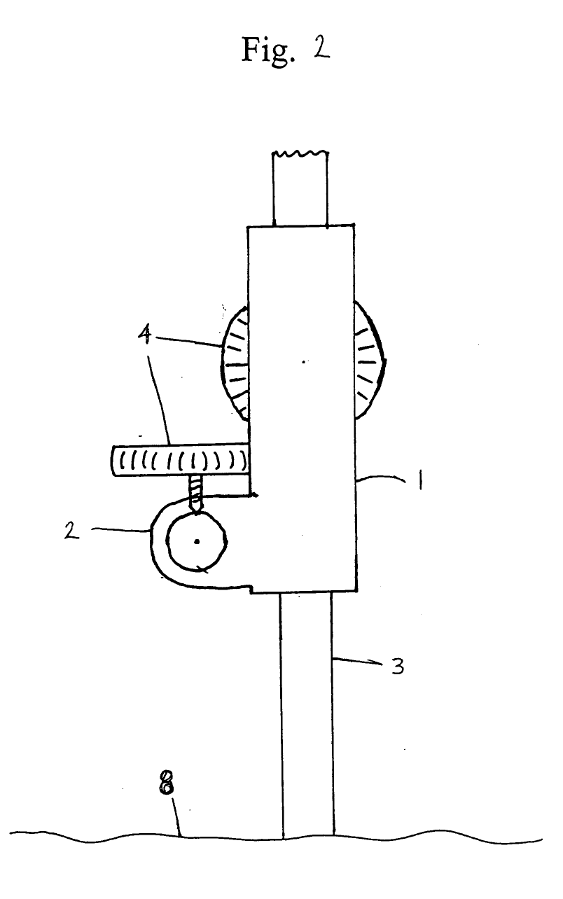

FIG. 3 shows a face view of said form support (5) with multiple gripping teeth (7) at the base, and multiple nail set holes (6) at the top of the plate. The horizontal pole is attached on the back of the plate and is not visible from this angle.

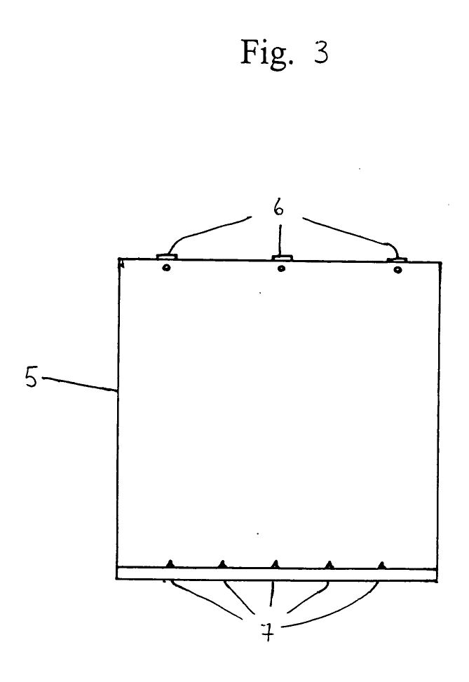

FIG. 4 shows a side view of an alternate type of form support (5) for use when the form support is installed in the corner of the foundation and two boards come together, such that a smooth and level corner is created by the form support.

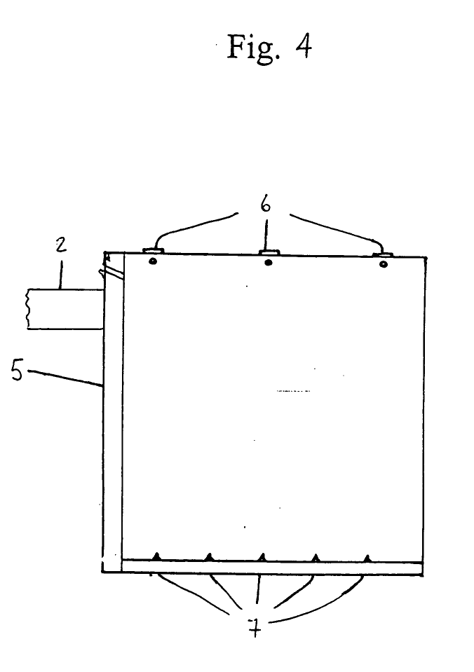

FIG. 5 shows the same form support as FIG. 4 but from above, with the horizontal pole (2) attached diagonally to the form support where the two perpendicular boards come together. The multiple gripping teeth (7) are shown on the horizontal inside surface of the form support, and the multiple nail set holes (6) for securing two perpendicularly placed intersecting boards.

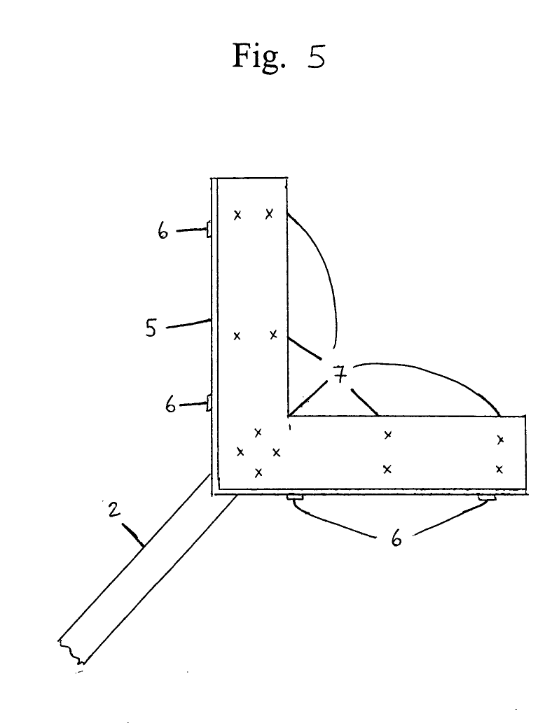

### DETAILED DESCRIPTION OF THE PREFERRED EMBODIMENTS

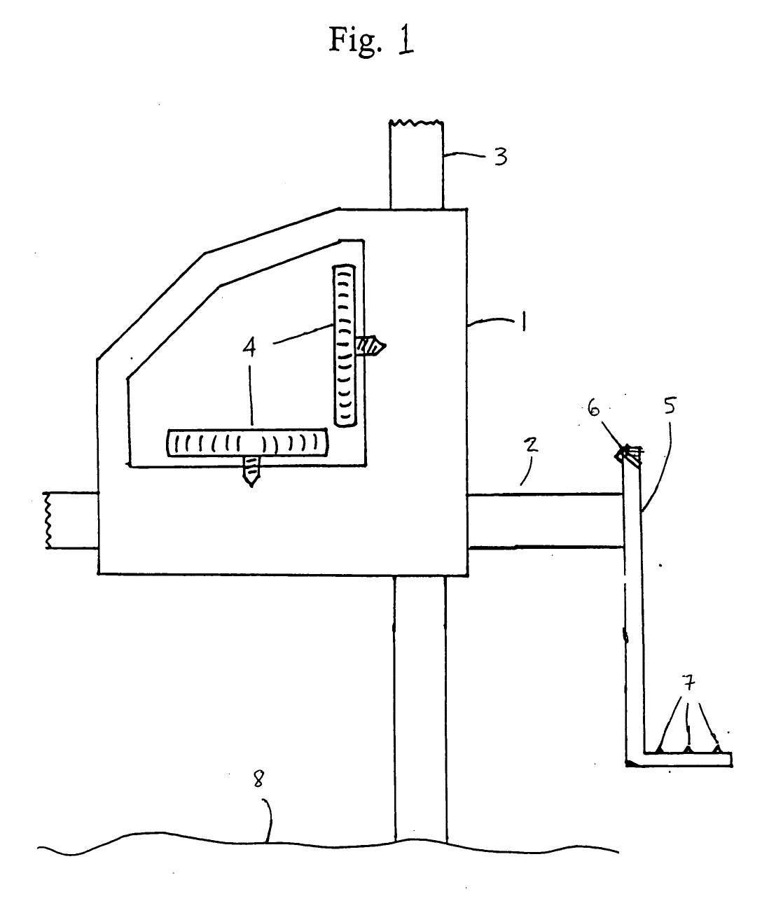

The descriptive terminology used herein is intended to be explanatory of the benefits of the invention and are not intended to be a description of limitation. Referring to FIG. 1 of the drawings herein, the invention in its entirety is installed individually as follows, but with multiple units in use at one job site for maximum efficacy. The vertical pipe is fitted through the vertical hole and then the vertical pipe is pounded into the ground in the desired location. Then, with the clamp plate on the ground, and the horizontal pipe in place, the desired wooden form is placed firmly on the form plate such that the gripping teeth engage the bottom of the board. A temporary set nail is driven into the 2×4 at the top to hold the board in place. Next, generally, the height is set by tightening the set screw on the vertical pipe, then the horizontal position is set by tightening the set screw on the horizontal pipe.

These steps are performed on all clamp units until the entire desired foundation area is defined. Next, the worker can fine-tune the vertical and horizontal settings on each unit, and on all units by sight, by string, by level, by survey, or by other methods that might be available.

Disassembly is also quite rapid. The worker only needs to remove the form board by removing the set nail and then pull up the metal pipe out of the ground. No “uncalibrating” is required after use, and in fact, it is desireable during transportation to have the set screws tightened on the vertical and horizontal pipes. The invention is durable, reusable, infinitely configurable, and easy to assemble and disassemble.

Although multiple aspects and uses of the invention have been described pictorially and in written form, it should be noted that other modifications and additions may be made thereto and without departing from the scope thereof. Having described my invention and the manner in which it may be used,

I claim:

1. A concrete foundation form system comprised of a clamping plate, a vertical stake sliding through the plate, a horizontal pole sliding through the same plate with an additional clamping form support at one end, and clamping mechanisms for both the vertical and horizontal sliding elements with said plate to be approximately 6 inches by 6 inches, and 1/4 inch thick, and said sliding poles to be approximately % inch in diameter and ½ to 36 inches long.

2. A concrete foundation form system as in claim 1, wherein the clamping plate is constructed of metal or other very durable material.

3. A concrete foundation form system as in claim 1, wherein the vertical stake is cylindrical, and pointed at the bottom end that enters the earth.

4. A concrete foundation form system as in claim 1, wherein the horizontal post is cylindrical and blunt or flat on the unused end.

5. A concrete foundation form system as in claim 1, wherein the form support end of said horizontal post has a vertical form plate attached to it that holds the wooden cement form board.

6. A concrete foundation form system as in claim 5, wherein said vertical plate has a horizontal base (the pediment) that supports the attached board.

7. A concrete foundation form system as in claim 5, wherein said plate has small, sharpened teeth on the top side of the horizontal face of the plate in order to temporarily grip or grab the attached board.

8. A concrete foundation form system as in claim 5, wherein the top of the vertical part of the plate has spaced holes through which nails or screws can be inserted into the upper portion of the form board to temporarily secure it to the plate.

9. A concrete foundation form system as in claim 1, wherein the said clamping plate is positioned vertically above the ground when installed and has two cylindrical tubes, one on each side of the plate; with one vertical tube running the height of the plate from top to bottom, and with the other horizontal tube running the width of the plate from one side to the other.

10. A concrete foundation form system as in claim 9, wherein said vertical tube on the clamping plate is penetrated by a threaded hole, through which a threaded bolt is inserted.

11. A concrete foundation form system as in claim 10, wherein said threaded bolt has a circular handle on the outside end for the purpose of tightening and loosening the bolt to the sliding post passing through the plate tube.

12. A concrete foundation form system as in claim 9, wherein said threaded bolt and handle are encircled by a semi-circular raised edge on the plate for the purpose of protecting the bolt and handle from physical harm.

13. A concrete foundation form system as in claim 9, wherein said horizontal tube on the clamping plate is penetrated by a threaded hole, through which a threaded bolt is inserted.

14. A concrete foundation form system as in claim 13, wherein said threaded bolt has a circular handle on the outside end for the purpose of tightening and loosening the bolt to the sliding post passing through the plate tube.

15. A concrete foundation form system as in claim 14, wherein said threaded bolt and handle are encircled by a semi-circular raised edge on the plate for the purpose of protecting the bolt and handle from physical harm.

16. A concrete foundation form system as in claim 1, wherein the entire invention can rotate to the left and to the right about the vertical axis on the vertical pole, and up and down, thereby permitting wide movement and positioning of the cement form.

17. A concrete foundation form system as in claim 1, wherein the entire horizontal pole and form support can rotate left and right about the horizontal axis on the horizontal pole, thereby permitting the cement form to be set on a slope or other uneven grade.
